(19) United States
(12) Patent Application Publication
(10) Pub. No.: US 2015/0035279 A1
(43) Pub. Date: Feb. 5, 2015

(54) Wave energy conversion system

(71) Applicant: William Joseph Ryan, Dade City, FL (US)

(72) Inventor: William Joseph Ryan, Dade City, FL (US)

(21) Appl. No.: 13/987,483

(22) Filed: Jul. 30, 2013

(51) Int. Cl. F03B 13/18

(52) U.S. Cl. CPC F03B 13/18
USPC 290/42; 405/76

(57) ABSTRACT

The Wave Energy Conversion System is a fresh or salt water wave induced land based system to convert wave action into circular power for compressed air, water pump, hydraulic oil pump and/or by attaching same to one or more high voltage generators. The system is capable of extracting tremendous power from minimal water movement, transferring same into a rotation system, with multiple high speed storage controlled regulatory loading systems utilizing the intense power. Having a greater reliability and longer range of stored and smooth power time, it does not rely on direct sun or wind but the longer lasting term effects of same on water. The system has the flexibility to be protected from periodic damaging waves, quick disconnects in the eventuality of hurricanes, ease of maintenance/repairs, for when assembled in a series or battery of cylinder systems, will be capable of producing rotation power rivaling any solar power system to date.

The Protean Energy Wave Converter, used in Australia, is a direct drive energy conversion, point-absorber wave-buoy device. This is a single platform system that must be placed offshore and anchored to the sea floor. Its use is limited to the manufacturing and provision of electricity transferred with long power lines. This is an expensive system to build and repair and could interfere with sea navigation. Also, this system is exposed to damage from storms at sea and is at the mercy of the elements.

SurgeDrive, used in Australia, is a tension transfer buoy design. This is a single platform system that must be placed offshore and anchored to the sea floor. Its use is limited to the manufacturing and provision of electricity transferred with long power lines. This is an expensive system to build and repair and could interfere with sea navigation. Also, this system is exposed to damage from storms at sea and is at the mercy of the elements.

PowerBuoy, used in the pacific northwest of the United States, is a wave-power buoy design and must be placed offshore, anchored to the sea floor and its use is limited to the manufacturing of electricity via hydraulic fluid within the buoy. It is approximately 145 feet tall and has a diameter of 36 feet. The concept of turning wave action outside the buoy to wave action inside the buoy is ineffective and does not utilize the full value of each wave. This is a single platform system that must be placed offshore and anchored to the sea floor. Its use is limited to the manufacturing and provision of electricity transferred with long power lines. This is an expensive barge system to build and repair and could interfere with sea navigation as it is five miles offshore. Also, this system is exposed to damage from storms at sea and is at the mercy of the elements.

Peamis Wave Energy Converter, used offshore of UK (Scottish) is a wave induced motion of a hydraulic cylinders. This power surface following attenuator system once more turning thinner water to move thicker oil under pressure is difficult to comprehend. This is a single platform system that must be placed offshore and anchored to the sea floor. Its use is limited to the manufacturing and provision of electricity transferred with long power lines. This is an expensive system to build and repair and could interfere with sea navigation. Also, this system is exposed to damage from storms at sea and is at the mercer of the elements.

Wave Dragon, used in Denmark is a surface following attenuator, offshore and uses hydroelectric turbines. This system converts waves via a ramp that pumps oil that turns the turbines. Once more, does not utilize the full power of each wave. This is a single platform system that must be placed offshore and anchored to the sea floor. Its use is limited to the manufacturing and provision of electricity transferred with long power lines. It apparently has a long, rocking tail that would clearly interfere with sea navigation and would be exposed to damage from storms for it has many moving parts.

Anaconda Wave Energy Converter; found in the UK relies on a tube that is underwater, in which a passing wave will instigate a wave inside the tube, driving a hydroelectric turbine. Once more, this concept depends on thinner water to move thicker oil. If there is a leak, oil will be on the beaches.

CETO Wave Power; found offshore in Australia and the SeaRaser; found offshore in the UK are pump-to-shore buoy designs that pump pressurized water via pipelines to an onshore facility to drive hydraulic generators. This is an expensive system to build and repair and could interfere with sea navigation.

Oyster Wave Energy Converter; found near shore on the UK (Scots Irish) is an oscillating wave surge converter that pumps hydraulic pistons to turn a turbine. Once more, there is the chance for oil leaks.

SDE Sea Wave Power Plant; found inshore near Israel is a buoy design that uses hydroelectric oil to drive a turbine. Oil leaks and corrosion from salt water on those lines could leak on the beaches.

WaveRoller; is a pump to shore system found offshore of Finland and is a pump to shore system, not unlike others described before.

Wave Star; this is a system found offshore near Denmark and once more uses a multi-point absorber (could be another way to describe buoy) and again is hydroelectric.

R38/50 kw,r115/150 kw; is found offshore in the UK and appears to be a buoy system (upper member and lower member) with some type of electrical conversion that is top secret at this time, maybe hydroelectric oil.

### SUMMARY OF THE INVENTION

### Brief Description of the Drawings

For a fuller understanding of the nature and objects of the invention, reference should be made to the following detailed description taken in connection with the accompanying drawings, in which:

FIG. 1 is a side view of the Wave Energy Conversion System showing in detail a single Lifting Flotation Container Housing (LFCH) and the self adjusting slides for higher waves and high tides combined with multiples of same via flexible connecting rods referred to as Lifting Flotation Container Housing Assemblages or (LFCHA.)

FIG. 2 shows a simple quick-disconnect drive shaft connecting assemblage designed for the LFCHA and the portable battery systems.

FIG. 3 is the top view of the Wave Energy Conversion Flotation Battery System or (WECFBS) showing the ability to assemble the LFCH in a battery style utilizing the LFCH in a more controlled environment, capable of multiples to be placed in less populated areas or powerless regions (e.g. those due to natural disasters) without the need of pilings or a pier.

FIG. 4 is a single front cutaway view and a side view of the Water Movement Transferring Multiple Storage Rotation Controlled Regulatory System or (WMTMSRCRS), which will even out the power from the waves maintaining smoother delivery to any required source.

FIG. 5 illustrates the use of a style of power output rotation system to be added to the storage regulator transferring or rotation storage regulator controlled systems utilizing the intense pressure for increased speed.

FIG. 6 exhibits a time-line examples showing an assemblage of eight of the LFCHA and their wave response as the conversion from wave to circular motion relates to the inevitable LFCH in its portion of lifting action.

FIG. 7 is the end view of the Wave Energy Conversion Flotation Battery System or (WECFBS) revealing the workings of the (LFCH) on both sides creating a right turning shaft and a left turning shaft.

FIG. 8 is a graft illustrating the variations in wave height occurring naturally in nature and the need for self adjusting slides and flexible connection rods.

FIG. 9 reveals a cut a way view of a single wave and the concept of illustrating same in to four points of power and the need to convert power by compressing same in to three thereby better utilizing all the wave power.

FIG. 10 shows the front view of the flotation cylinder designed to capture all of the wave's power maximizing lifting and power conversion via mimicking commonly found wave action and their contours capturing the underutilized upper wave in individual containers or inverted cups with ever expanding sides to an upper max wave absorber and drip tip called the Wave Mirror.

FIG. 11 gives a side view of the Wave Mirror in application to the (LFCH) that better converts the individual wave in to upper movement via a hinge system with safety feathers such as an upper stop and lower stop and a built in large wave absorber preventing damage to the system via an individual or small sanomia.

### DETAILED DISCRIPTION

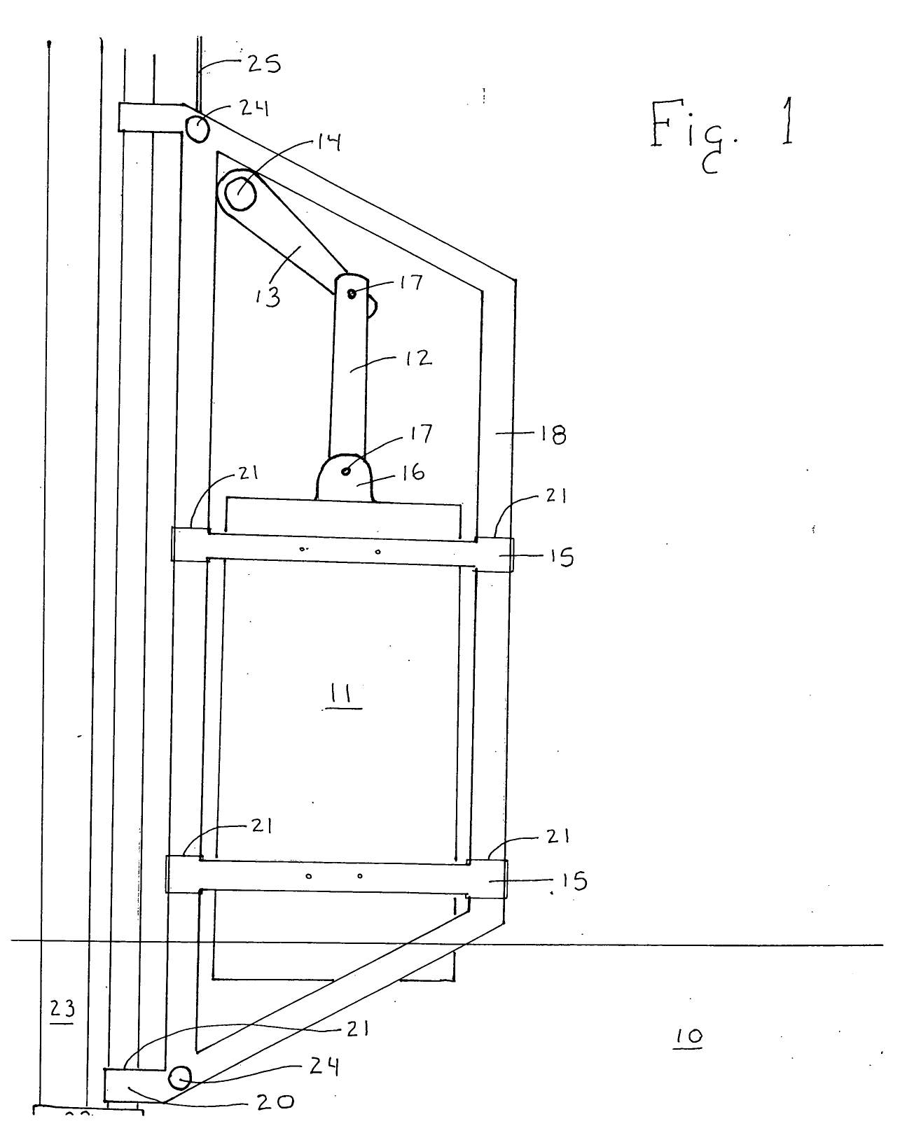

Referring to FIG. 1, one may see, a partial side view of a preferred embodiment of the energy transfer cylinder filled with ground level air presser and sealed (11) resting on top of a body of water (10) in preparation of a wave, that would lift up said energy cylinder affixed to four stabilizing lift slide bars (15), thereby putting upward pressure on the connecting rod (12) held in place by two connecting pins (17) which are attached to the top of the cylinder via a U plate (16) and transfer same to the slip clutch ratchet arm (13) thereby rotating the drive shaft (14) a porcine of one revolution. The porcine of the limited revolution is determined by the height of the wave as well as the pressure being transferred and placed on the drive shaft (14.)

This assemblage hereby referred to as the Lifting Cylinder Housing or (18) and hereafter referred to as the LCH, holding the main thrust assembly, rests on the slide LFCH lifting bars (19) via four stabilizing lift cuffs (20) (similar to the stabilizing lift bars found in 15.) Both the stabilizing lift bars (15) and the stabilizing lift cuffs (20) utilize a self lubricating material, such as Teflon, but not limited to same (21) that permits ease of movement on the sliding surfaces (19) and (18.) This enables the entire LFCH to move freely upwards with the rising tides and with single intermittent super waves or tsunami type waves that will help prevent damage to the system.

The main thrust assembly (19) is a sealed system filled with flotation material such as styrene, but not limited to same, to give buoyancy for maintaining over all levelness to the entire system is held in place via fixed clamps (22) numbering two per bar or four per LFCH that are firmly secured to the pilings of a pier or bridge (23.) A series of these LFCH assemblages or hereafter referred to as LFCHA, can be secured'to multiple pilings with a preferred minimum of eight (but not limited to same) with each connecting to the other via a flexible connecting rod (24) that will aid in the stabilization of rough seas utilizing maximum power provided by each wave. Maintenance would be achieved via a series of lift cables attached to the top of the pier as well as the top of each LCH (25) utilizing a crank system that would connect to the LFCHA and would raise the entire system up and out of the water.

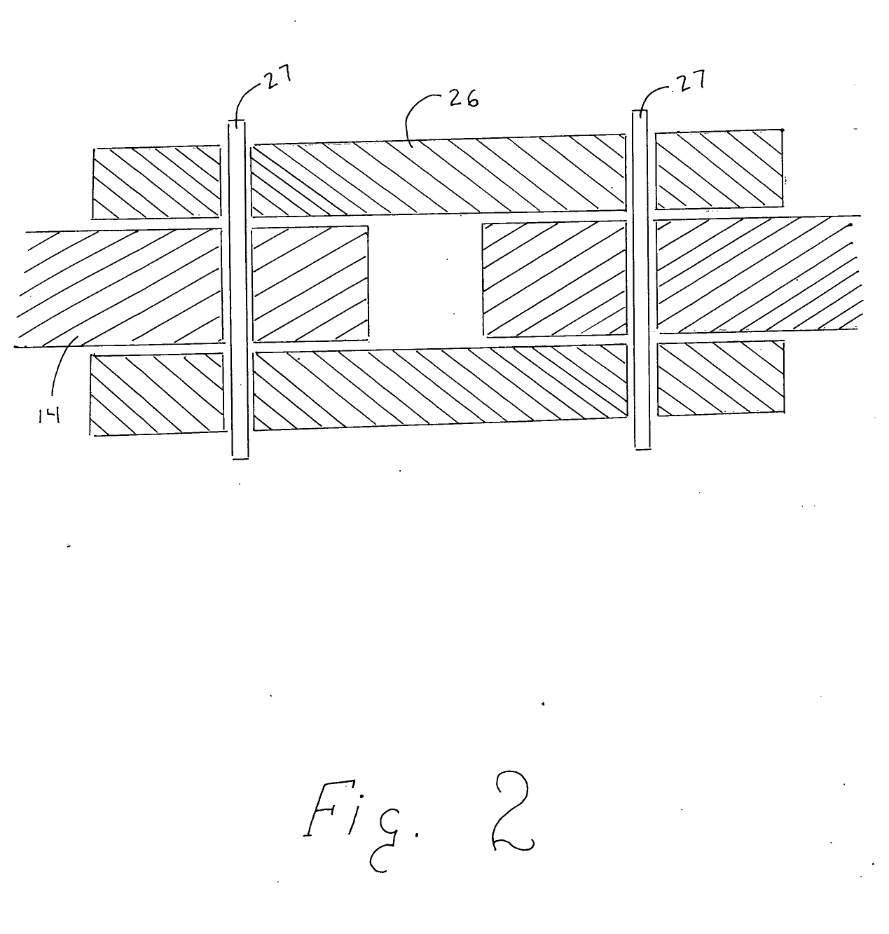

Referring to FIG. 2 one may see the drive shaft coupling system that will be required to connect each LFCHA drive shaft (14) together with the coupler (26) and be affixed via a connecting pin(s) (27) thereby locking in place.

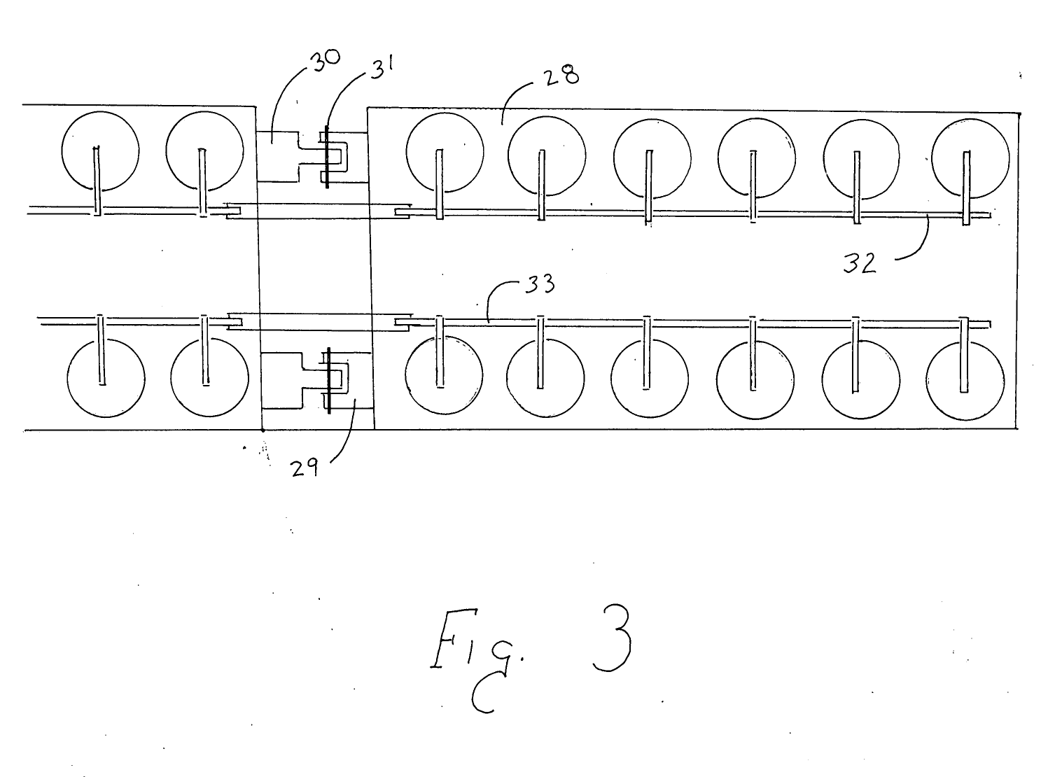

Referring to FIG. 3 one may see multiples or a battery of the LFCH system utilized in a single (28) flotation called the Wave Energy Conversion Flotation Battery System or WECFBS. It has the ability to be connected via pivot female latches (29) and male pivot latches (30) held together with latching pins (31) in a series creating a multiplying effect to its outcome.

The right and left banks of the WECFBS will not require a flexible connecting rod (24 FIG. 1), as the Flotation Battery (28) would replace the need. The lifting cylinder housing or LCH (18 FIG. 1), would be modified due to the replacement of the lifting bars (19 FIG. 1,) as they would be also replaced with 28 the Flotation Battery. Because the drive shaft (14 FIG. 1) is closer to the sealed cylinder (11 FIG. 1), the need of the connecting rod (12 FIG. 1) would be eliminated or shortened. Both right drive shaft (32) and left drive shaft (33) which consist of one piece for the full length of the WECFBS would then be require only one drive shaft connecting coupler on the end of each shaft (32 FIG. 2), making it possible to add an additional Flotation Batteries (WECFBS) for additional power or connect to any final rotating power need.

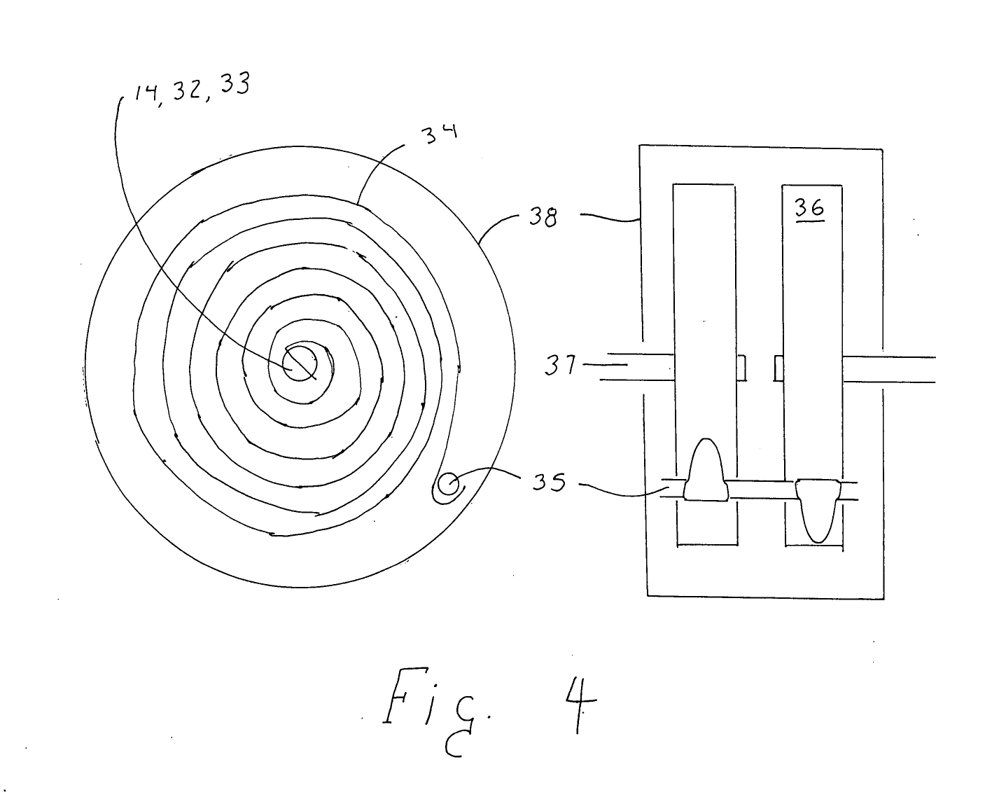

Due to the slow rotating movement of this battery system (WECFBS) there could require a need for regulating the uneven action of the waves via a Water Movement Transferring Rotation Storage Regulatory Controlled System or (WMTRSRCS) (FIG. 4 showing a front and side view) which would provide a smoother delivery system as well as Short Term Storage or STS (34.) At the end of the drive shaft (14 FIGS. 1 and 32 and 33 FIG. 3) is anchored to one end of a spring. The opposing end of the STS is held firmly secured in place via the securing pin (35). A second opposing spring (36) doubles the storage of the STS then releasing the rotation more evenly to the required need via an additional shaft (37). A case is surrounding the STS (38) would allow the system to be secured and preventing injury to man and machine.

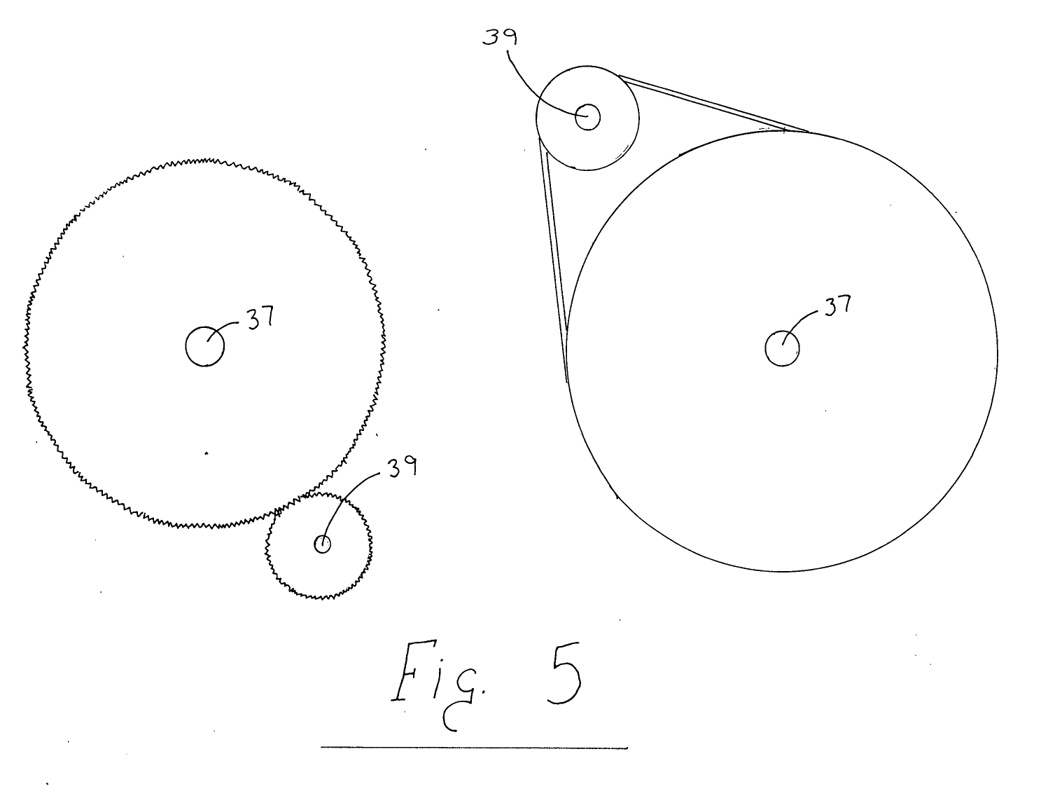

This system of a series of WECFBS will provide a slower moving rotation than may be required for some applications, but due to the extreme power output of the WECFBS a Gear or Belt System (GBS) to increase the rotations power could be placed between the final output shaft (37) from. FIG. 4 is the same in (FIG. 5) and the required need via utilizing a (GBS) found in (FIG. 5) showing the now geared up output shaft (39).

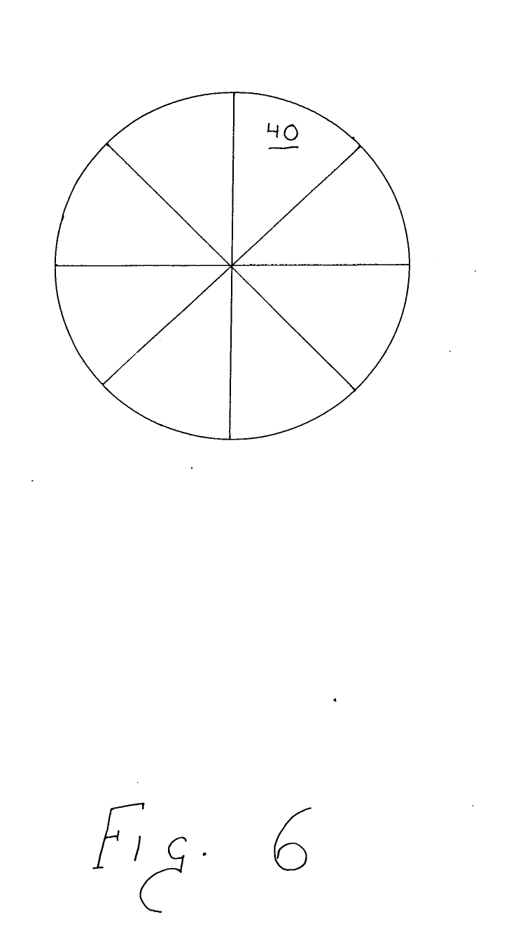

FIG. 6 is a cut an end view of the drive shaft before the WMTRSRCS in (FIG. 1, 14) or (FIG. 3, 32, 33) to expose the movement of the shafts reaction to each wave via the lifting of eight LCHs placed in a row. Eight LCHs would provide a good use of each wave's ability turn the drive shaft mutable times and the dispersion of each LCH would insure a single wave would always be turning the shaft. So it is clear twenty LCHs would have several waves at any given time turning the shaft. This example shows eight LCHs and their conversion of lifting to turning as one eight (40) is but one LCH wave action.

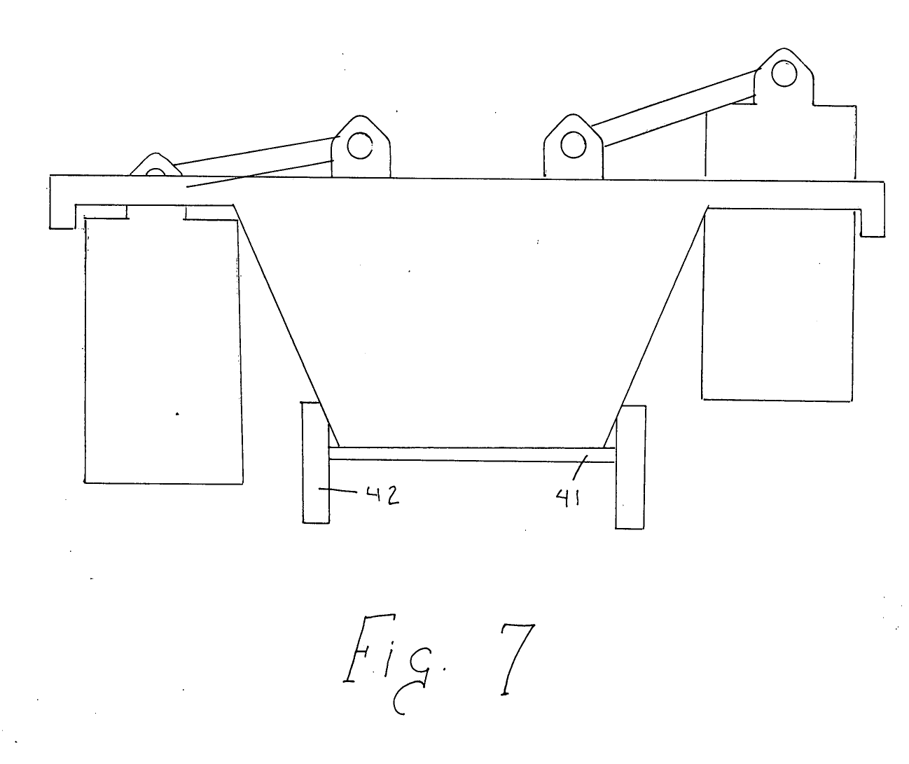

Referring to FIG. 7 The WECFBS would be equipped with an axle (41) to which a round air-filled rubber tube (42) would be attached. Both the axle and the tube are to be made of a non-corrosive material such as rubber, ABS or PVC, but not limited to same.

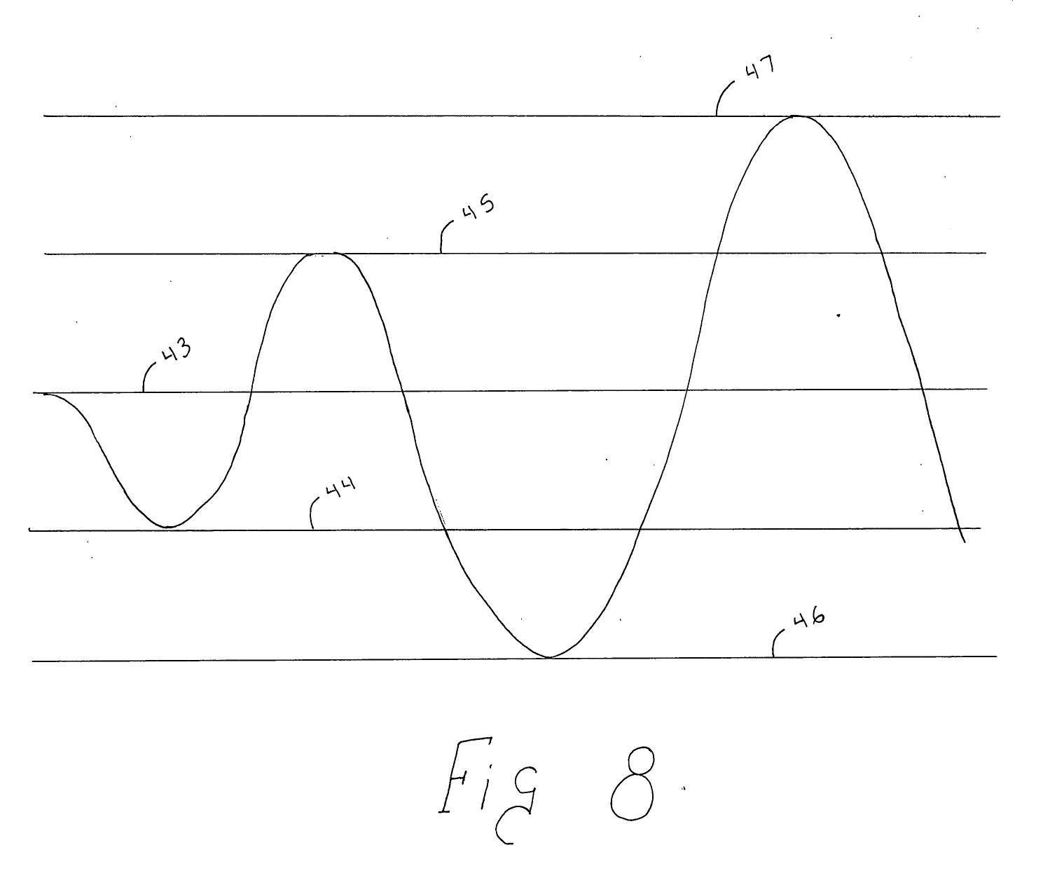

FIG. 8 shows a cut away view of two styles of waves (43) is the waters height if there were no waves or (still water). (44) is representative of the average low end of a wave and (45) is the average high end of a wave, were as (46) represent a high wave or tsunami at its low point and (47) is representative of a high wave or tsunami at its high point. This sometimes change in wave height is the reason for the self adjusting slides found in FIG. 1 numbers (19, 20, 21) and the need for the flexible connecting rods (24) found in same FIG. 1.

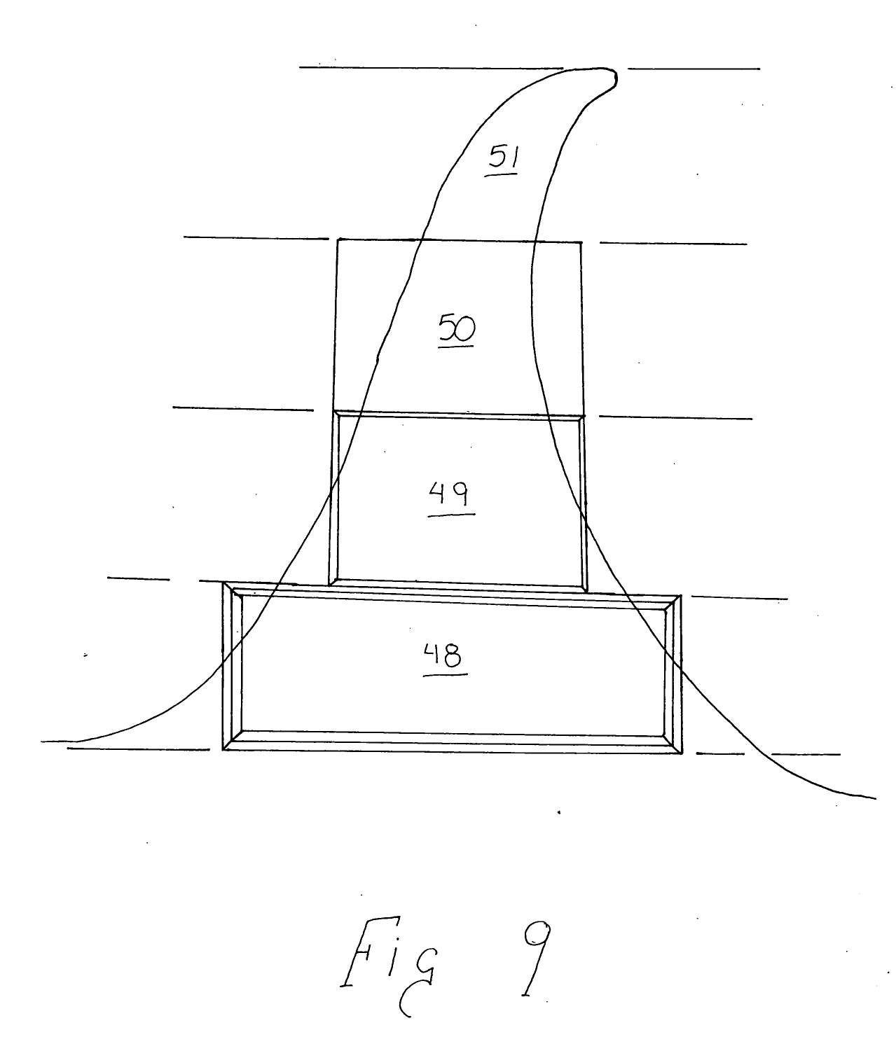

FIG. 9 reveals another cut a way view of a single wave shown here to have four stages of power that are needed to be captured in a design that best represents each average wave as power blocks. (48) Is stage one of the largest wave power block and will give the most lift because the with but its height is limited. (49) Is stage two and is reduced in size. but gains power in its mass and speed. (50) Is stage three and narrows in with, but as in stage two has accelerated speed only grater yet this is the start of the lost portion that is underutilized and not captured. (51) Represents the upper portion of the wave, stage four and is the fasts moving portion and most underutilized or lost completely. The goal is to merge stage three with stage four in block (50) capturing the speed and power.

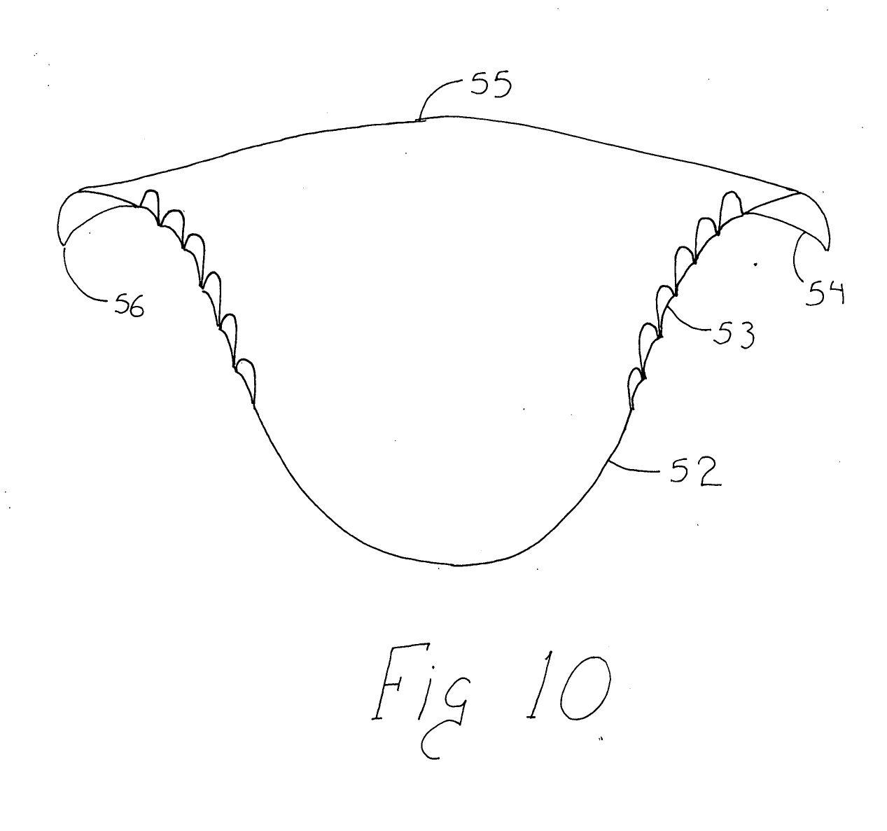

FIG. 10 provides a front cut a way view of the Wave Wedgie and (52) being the outer lower portion that utilizes power block one, (48) FIG. 9, contouring to the low curve between a given wave thereby utilizing all the lifting power found within each wave. Further up the outer side wall of the perfectly contouring Wave Wedgie are found numerous of the Wave Wadgie Cavities set in rows offset to each other (53) designed to capture the upward moving side wall of stage two power block two found in (49) FIG. 9, and capturing its movement turning same in to lift. (54) The finial and largest of the Wave Wadgie Cavities curves back down to best capture stage three (50) and the lost portion of any given wave (51) FIG. 9 turning same in to lift power. (55) Is the upper cover that provides perfect tilt to drain off any and all over spray or rain to the outer edges where there are drip tips (56).

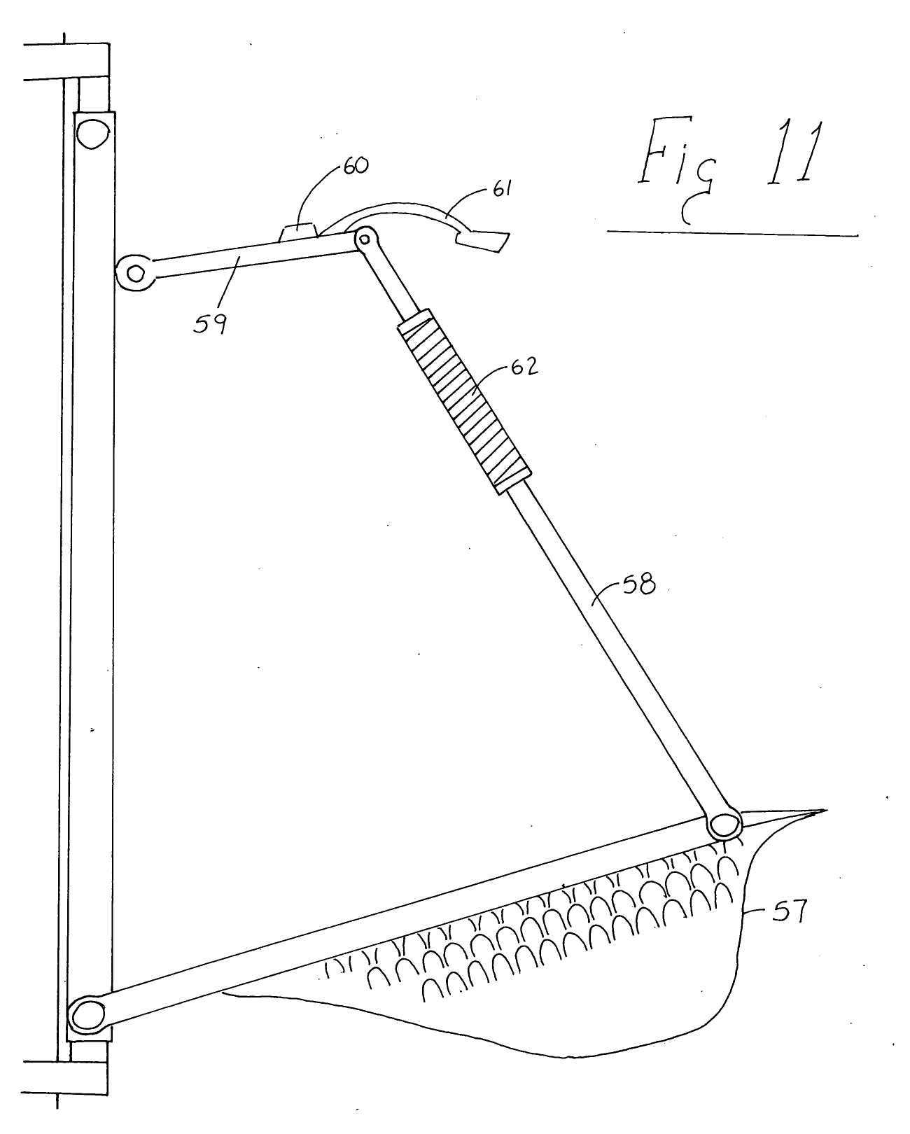

FIG. 11 reveals a side view of the Wave Wadgie utilizing many of the same attributes found in FIG. 1 but less parts to be exposed to damage and a simpler design. (57) Illustrates the Wave Wadgie Cavities in offset rows to capture the up lifting power of each wave. As the up word lift motion of each wave is captured it is then transferring same to the lifting rod (58) that in turn transfers same to the ratchet (59) turning the drive shaft. The upgraded features of this ratchet are the lifting stop (60) that prevents the turning of the drive shaft to go beyond a point that could cause damage. There is a second stop (61) with a spring arm that prevents the ratchet from returning to a down position that could also cause damage. The lifting rod (58) is equipped with an absorber (62) that in the event of a tsunami previously detailed in FIG. 8, (47) damage would be prevented by the extreme lifting power of the wave. The absorber in the up position with the lifting stop at its maximum upward position would prevent damage by bending and flexing freely.

What is claimed is:

1. A solar wave conversion power system land based fresh or salt water wave induced powered conversion system whereby the actions of the waves are transferred to a flotation container secured in a lifting flotation housing attached to sides of a dock, pier, bridge piling, barge or vessel, but not limited to; said body comprising of non corrosive material such as ABS, PVC, CPVC or coated in same, then transferred said lifting action to a flexible rotary shaft, made with single couplers, or utilizing a one piece drive shaft made of stainless steel cable with swaged couplers, via a lifting arm or series of arms to a shock wave absorbing clutch release system, that power is then moved to a gear or belt transmission whereby the slow but powerful turning action is then sped up, whereby any number of device could be attached to this rotary shaft such as a pump for water or hydroelectric, an electric generator, but not limited to.

2. This solar wave conversion power system found in claim 1 with flotation material is permitted to slide securely and adjust to the rising tides and/or larger waves on a self lubricating slide pole next to the piling and would permit removal from the water for maintenances and repairs via same utilizing lifting cables, but not limited to same.

3. The solar wave conversion power system found in claim 1 can be placed in a series and held in place via a flexible strong pole or connecting rod that maintains a level of evenness between each flotation system.

4. The solar wave conversion power system found in claim 1 can be placed in a series thereby multiplying each waves effect better utilizing and capturing the power of each wave, this line or battery consisting of, but not limited to, two banks secured to a flotation device such as a barge or pondtone providing stability and mobility.

5. The solar wave conversion power system found in claim 4 has the ability to assembled in a series via couplers wherein multiples of this system can utilize the wave action and convert same into a more powerful and constant rotation.

6. The solar wave conversion power system found in clam 4 and 5 now having rotation but requiring additional stability can be done via a water movement transferring rotation storage regulator controlled system.

7. The solar wave conversion power system found in claim 6 now having stability in rotation, may require additional speed for certain applications and can be done via an extreme power output rotation accelerator system.

8. The solar wave conversion power system found in claim 6 will capture the upward movements of the lifting power in the unlikely designed Wave Wedgie Cavities that utilize the entire wave in all aspects of its movements.

9. The solar wave conversion power system found in claim 6 will have a system of preventing damage to the lifting rod and ratchet via stops and a wave absorber.
